(19) United States
(12) Patent Application Publication
(10) Pub. No.: US 2014/0155161 A1
(43) Pub. Date: Jun. 5, 2014

(54) Image Rendering Systems and Methods

(71) Applicant: Camber Corporation, Huntsville, AL (US)

(72) Inventors: Brian Patrick Davis, Madison, AL (US); Laura Alaina Kee, Madison, AL (US); Jeremy Scott Reddoch, Madison, AL (US); Richard Earl Pilcher, II, Huntsville, AL (US)

(21) Appl. No.: 14/098,413

(22) Filed: Dec. 5, 2013

Related U.S. Application Data
(60) Provisional application No. 61/733,526, filed on Dec. 5, 2012.

(51) Int. Cl. A63F 13/00

(52) U.S. Cl. CPC A63F 13/00
USPC 463/31

(57) ABSTRACT

The present disclosure is a gaming system that has a gaming module that generates and renders gaming image data to a display device and a communication module that generates viewport image data. Additionally, the gaming system has logic that intercepts a rendering operation of the gaming module and determines a location of the gaming image data. Further, the logic further generates combined image data by combining the gaming image data with the viewport image data and performs a rendering operation for display of the combined image data to the display device.

### CROSS REFERENCE TO RELATED APPLICATION

This application claims priority to U.S. Provisional Application Ser. No. 61/733,526 entitled Image Rendering System and Method, filed on Dec. 5, 2012, which is incorporated herein by reference.

### BACKGROUND

Oftentimes simulation software, e.g., Virtual Battlespace Systems 1 (VBS1) and Virtual Battlespace Systems 2 (VBS2), enable end users to practice military tactics in an interactive multiplayer three-dimensional (3D) environment. In this regard, the simulators provide for an interactive training environment, for example, for military personnel. In regard to the interactive environment, the simulators may allow the end users to generate particular scenarios and emulate task management, resource management, personnel management and the like in response to the particular scenario. Notably, simulation software may be classified as a type or a subset of gaming software.

In the gaming industry, middleware is often used that interfaces with the gaming software to enable more robust functionality in a gaming environment created by the gaming software. In this regard, some middleware, e.g., Scaleform GFx, enables the gaming software to superimpose images, e.g., Adobe Flash movies, on top of images normally rendered by the gaming software. In this regard, the described middleware enables a developer of the gaming software to build GUIs and incorporate the built GUIs into a gaming experience, among other functionality.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram of an exemplary gaming system in accordance with an embodiment of the present disclosure.

FIG. 2 is an exemplary image that may be displayed to the display device depicted in FIG. 1.

FIG. 3 is an exemplary depiction of a plurality of displayed viewports in accordance with an embodiment of the present disclosure.

FIG. 4 is a block diagram of an exemplary gaming system depicted in FIG. 1.

FIG. 5 is a block diagram depicting exemplary data flow of the gaming system depicted in FIG. 1.

FIG. 6 is a flowchart depicting exemplary architecture and functionality for the control logic depicted in FIG. 1.

### DETAILED DESCRIPTION

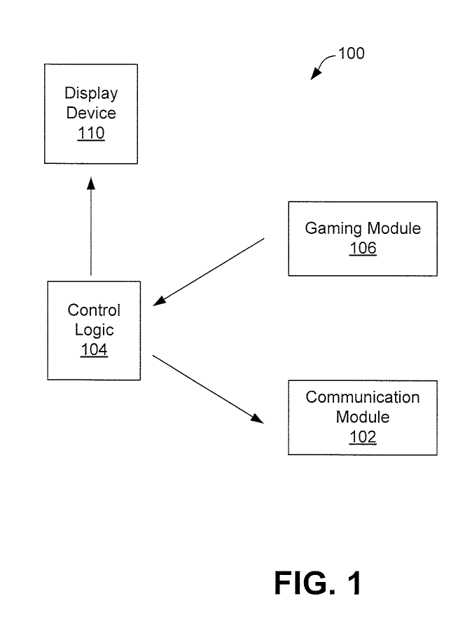

FIG. 1 is a block diagram illustrating an image rendering system 100 in accordance with an embodiment of the present disclosure. The image rendering system 100 comprises a gaming module 106, a communication module 102, and control logic 104. Note that the control logic 104, the gaming module 106, and the communication module 102 may be software, hardware, firmware, or any combination thereof. In addition, the image rendering system 100 further comprises a display device 110.

The gaming module 106 allows a user (not shown) to develop gaming environments that may comprise simulated environments, e.g., terrains. The term “gaming environment” of the present disclosure is broadly used to encompass any interactive simulation for use in other applications, such as, for example, interactive training.

The gaming module 106 allows a user to populate the simulated environment with objects and texture-maps. In this regard, the gaming module 106 provides a simulation of real-world characteristics in conjunction with the simulated environment. As an example, the gaming module 106 creates visuals for moving objects (e.g., trees, grass, vehicles, etc.), shadows, lighting, weather, urban areas (e.g., accessible building). Other visuals are possible in other embodiments. Such list provided is not exhaustive but used for illustrative purposes only. In one embodiment, the gaming module 106 enables the user to create and develop video games, which can encompass elaborate environments used, for example, in entertainment or sophisticated training.

In addition, the gaming module 106 allows a user or multiple users to operate in the developed simulated environment. In this regard, the gaming module 106 enables the user or the multiple users to carry out and review (once completed) a simulated mission in the developed simulated environment. Note that in one embodiment, the gaming module 106 provides a three-dimensional environment (3D environment).

The gaming module 106 may be used for a variety of applications. For example, the gaming module 106 may be used in entertainment or for training (e.g., in the military arena), as identified hereinabove. Further, any type of gaming module 106 known in the art or future-developed may be used in the implementation of the image rendering system 100. As mere examples, the gaming module 106 may be Virtual Battlespace 2 (VBS2), which was developed for training of military personnel. Another example is Unity, which is also a game development tool.

During operation of the image rendering system 100, the gaming module 106 displays simulated environments to the display device 110. Further, the gaming module 106 manipulates the simulated environments while displayed to the display device 110, as indicated hereinabove. For example, during a gaming (or training) session, i.e., when operations (in the form of input from human interface devices) are being performed by the user (or users) in the simulated environment, the gaming module 106 may add dynamic objects (e.g., trees, grass, or animals), shadows, lighting, etc., which create the impression that the user is operating in a real-world environment.

In addition, the gaming module 106 reacts to user input, which may be received via a touch screen (not shown), a mouse (not shown), a microphone (not shown), or any other type of input device known in the art or future-developed. In response to the user input, the gaming module 106 may generate messages that may be interpreted to perform various operations including changing modes of operation in the simulated environment.

The communication module 102 (separate and apart from the image rendering system 100 and without the control logic 104) graphical user interface (GUI) renderer. In one embodiment, the communication module is an independent, self-contained single GUI renderer.

The communication module 102 provides customizable user interfaces and enables functionality with respect to the user interfaces, including the ability to enable a GUI, disable a GUI, interact with a GUI, position a GUI, or manage communications to/from a GUI.

Any type of communication module 102 known in the art or future-developed may be used in the implementation of the image rendering system 100. As mere examples, the communication module 102 may be Scaleform GFx.

In one embodiment, the communication module 102 may use a pre-generated image and provide the above listed functionality to the image in the form of a GUI displayed to the display device 110. In this regard, an image builder, (e.g., Adobe Flash) may generate image data, i.e., data indicative of an image or movie (a series of images). The communication module 102 displays a GUI comprising the generated image and controls interaction with the GUI. For example, the communication module 102 may allow a GUI created with an Adobe Flash image to be enabled, disabled, interacted with, positioned, or managed.

Note that in one embodiment, the gaming module 106 and the communication module 102 may be used separate and apart and have standalone functionality. The gaming module 106 alone may be used to generate the simulations described above, and the communication module 102 may be used to generate, render, display, and manage graphical user interfaces.

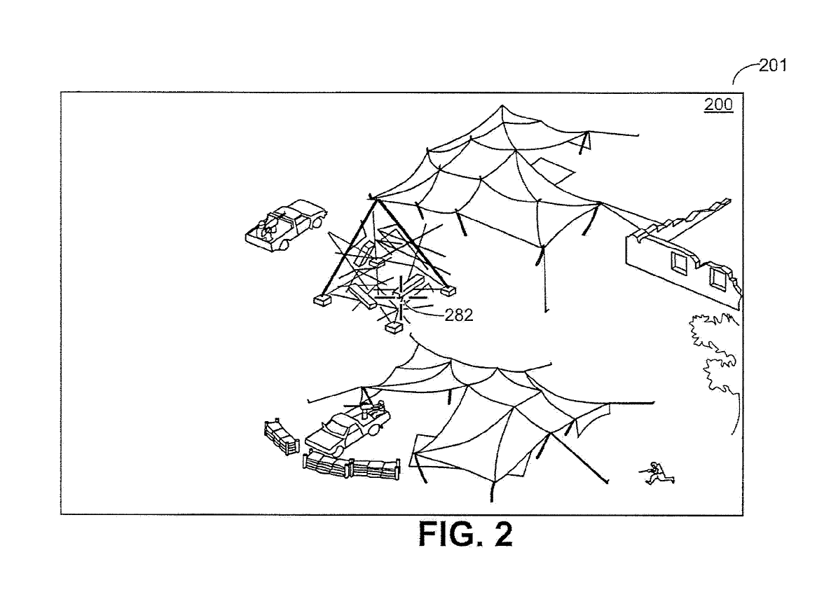

With reference to FIG. 2, in prior art systems, the gaming module 106 generates an image 200, renders the image 200 in memory, and displays the rendered image 200 in a viewport 201 on display device 110. The gaming module 106 further displays an interactive graphical element, such as a cross hair 282 embedded within the image 200.

As noted herein, during operation the game module 106 displays the image 200 to the display device 110, and the game module 106 may add real-world characteristics to the image 200 while the user (or users) operates virtually in the simulated environment exemplified by the image 200. Input devices, such as a keyboard, a mouse, a touch screen, or other user input devices may be used to interact with the gaming module 106 and otherwise control or influence what occurs with respect to the image 200 and the viewport 201.

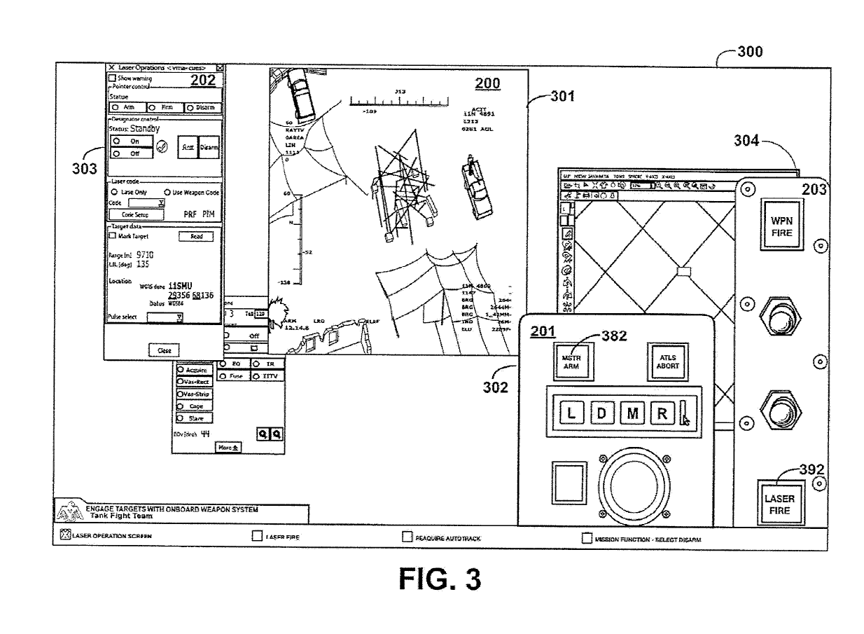

In the exemplary image rendering system 100, the functionality of the gaming module 106 and the communication module 102 are woven together via the control logic 104. In this regard, the control logic 104 interfaces with the communication module 102 and the gaming module 106 to facilitate generation and display of a viewport such as the viewport 300 depicted in FIG. 3.

The exemplary viewport 300 exhibits the image 200 in a viewport 301 in accordance with an embodiment of the present disclosure. In addition to displaying the image 200 in viewport 301, the control logic 104 further displays one or more additional viewports 302-304. Each viewport 302-304 comprises an interactive GUI with which a user may provide input to the image rendering system 100 or the image rendering system 100 may display information to the user of the image rendering system 100.

The viewport 303 displays dialog box 202. The viewports 302 and 304 display virtual human interface devices (HIDs) 201 and 203, respectively. Note that the term “virtual human interface device” is a GUI that mimics a real world controller or other input device. Note that the dialog box 202 and the virtual HIDs 201 and 203 are comprised of displayed images formed from data rendered in memory by the communication module 102.

In one embodiment, the virtual HIDs 302 and 304 comprise one or more interactive graphical images, e.g., pushbuttons 382 and 392, respectively. During operation, when a user (not shown) selects the pushbuttons 382 or 392, the control logic 104 responds (if necessitated by the action) by performing a predefined operation, e.g., generating and transmitting a message to the gaming module 106 or the communication module 102, which is described further herein. The gaming module 106 and the communication module 102 may then perform operations that effect what is displayed to the other viewports or the mode of operations.

In generating the viewport 300 depicted in FIG. 3, the control logic 104 combines gaming image data 200 generated by the gaming module 106 and viewport image data described further herein generated by the communication module 102. Further, the control logic 104 manages communication between the various viewports 301-304 displayed to the display device 110 and enables a user to separately control the order of display of the various viewports, i.e., 301-304.

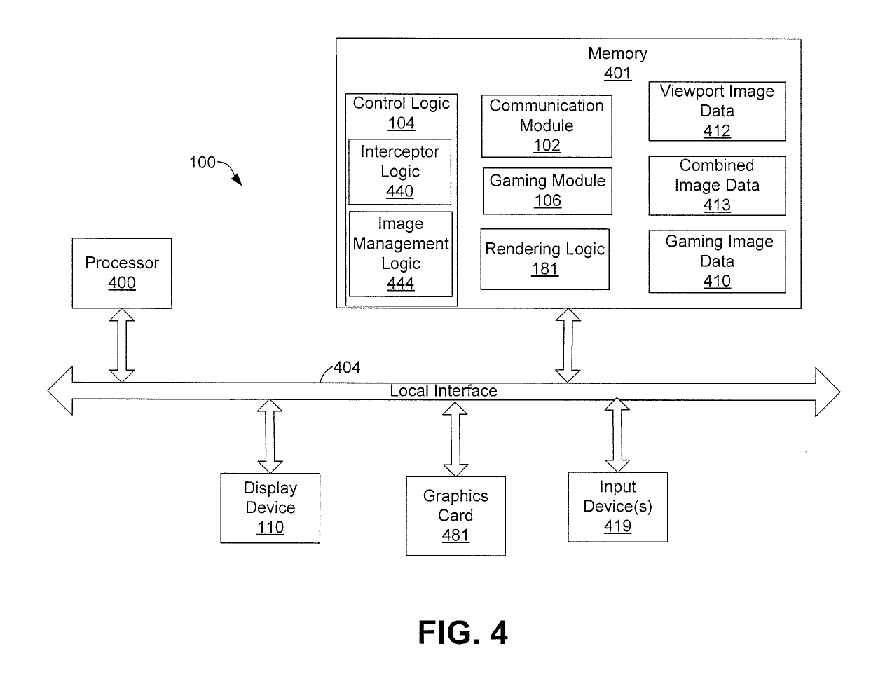

FIG. 4 is a block diagram of an image rendering system 100 in accordance with an embodiment of the present disclosure. The image rendering system 100 comprises a processing unit 400, the display device 110 (also shown in FIG. 1), an input device(s) 419, a graphics card 481, and memory 401. Each of these components communicates over a local interface 404, which can include one or more buses.

The image rendering system 100 comprises the control logic 104 (also shown in FIG. 1), the communication module 102, rendering logic 181, and the gaming module 106. Note that the communication module 102, the gaming module 106, and the rendering logic 181 may be software, hardware, firmware, or any combination thereof.

The control logic 104 comprises interceptor logic 440 and image management logic 444. The control logic 104 (including the interceptor logic 440 and image management logic 444) can be implemented in software, hardware, firmware or any combination thereof.

Note that the control logic 104 comprises functionally separate logic modules, including the interceptor logic 440 and the image management logic 444. Such independent illustration in FIG. 4 is for clarification and exemplary purposes only. In this regard, in other embodiments, the interceptor logic 440 and the image management logic 444 may be combined into a single module, and separation and distinction is for exemplary purposes only to further effectuate understanding of the image rendering system 100.

In the exemplary image rendering system 100 shown in FIG. 4, control logic 104 is implemented in software and stored in memory 401. Memory 401 may be of any type of memory known in the art, including, but not limited to random access memory (RAM), read-only memory (ROM), flash memory, and the like.

The image rendering system 100 further comprises viewport image data 412, gaming image data 410, and combined image data 413. Each image data 410, 412, and 413 is described further herein with reference to the gaming module 106, the communication module 102, and the control logic 104.

The rendering logic 181 is any type of logic known in the art or future developed that may be called, initiated, or used by other components, e.g., the gaming module 106, to render images to the display device 110. Exemplary rendering logic 181 may be, for example, DirectX or OpenGL. In the examples provided, both DirectX and OpenGL are application programming interfaces (APIs) for rendering two or three-dimensional images to the display device 110. Note that both DirectX and OpenGL define a plurality of functions, i.e., a series of program instructions to be executed by the processor 400, that when used render images to the display device 110.

Processing unit 400 may be a digital processor or other type of circuitry configured to run the control logic 104 by processing and executing the instructions of the control logic 104. The processing unit 400 communicates to and drives the other elements within the image rendering system 100 via the local interface 404, which can include one or more buses.

The input device(s) 410 may be any type of input device known in the art or future-developed. In this regard, the input device 419 may be a mouse, a keyboard, a touch screen, or any type of hardware that is communicatively coupled to the local interface 404 from which the processor 404 receives input. Notably, in one embodiment, the input device 419 may be wirelessly coupled to the local interface 404.

During operation, the gaming module 106 generates and stores in memory 401 the gaming image data 410. The gaming image data 410 comprises data indicative of, for example, a combat or military environment. Note that the gaming image data 410 is shown as stored in 401, and in one embodiment, the gaming image data 410 is stored at a particular memory location in the memory 401 of the system 100 that may be accessed through use of the particular memory address.

During operation, the interceptor logic 440 determines the location in memory corresponding to the gaming image data 410, i.e., the memory address, and transmits data indicative of the memory address to the image management logic 444.

Note that the location in memory of the gaming image data 410 may change throughout operation of the system 100. For example, each time the gaming module 106 performs a render pass, the gaming module 106 may store the gaming image data 410 at a different location than the location at which the gaming image data 410 was stored in a previous render pass.

The communication module 102 generates the viewport image data 412 to be displayed in one or more viewports 302-304 and transmits data indicative of one or more locations in memory of the viewport image data 412 to the image management logic 444. Note that the viewport image data 412 is data indicative of a viewport, e.g., viewport 301-304 (FIG. 3). In an embodiment wherein the communication module 102 is Scaleform, as indicated hereinabove, the viewport data 412 may be, for example, data indicative of Adobe Flash movies.

The image management logic 444 generates combined image data 413 that comprises data indicative of each of the viewports defined in the viewport image data 412 and the gaming image data 410 and displays the combined image data 413 to the display device 110.

Without activation of the control logic 104, during normal operation, the gaming module 106 generates the gaming image data 410. The gaming module 106 then executes a function call provided by the rendering logic 181 that renders the gaming image data 410 to the display device 110.

However upon activation of the control logic 104, the control logic 104 intercepts the gaming module's attempt to call the rendering logic 181, and instead generates the combined image data 413. Thus, in the scenario wherein the control logic 104 is operating, the image management logic 444 calls the function call of the rendering logic 181 after the combined image data 413 is generated, and the rendering logic 181 renders the combined image data 413 to the display device 110.

In addition, during operation the image management logic 444 receives messages generated by the input devices 419 corresponding to each of the viewports 301-304 (FIG. 3) and responds accordingly, as described further herein.

In one embodiment, the interceptor logic 440 may monitor function calls by the gaming module 106 to the rendering logic 181. In one embodiment, during development, a predetermined sequence of function calls is identified that indicates that an image is going to be rendered through the rendering logic 181. Thus, during operation, the interceptor logic 440 determines if a monitored sequence of function calls indicates that an image is going to be rendered to memory for later use by the image management logic 44. In this regard, the interceptor logic 440 may determine that a specific image that is being rendered is to be replaced by an image generated by the communication module 102, i.e., the gaming image data 410 may be one or more images that are formed together to form the gaming image data 410. Notably, the gaming image data 410 may comprise a number of separate images that are used to generate various components (e.x. a billboard, security camera screen, etc.) of the gaming image data 410. If the image management logic 444 identifies an image that is to become part of the gaming image data 410, the image management logic 444 may replace the image with a different image provided by the communication module 102.

Note that when the interceptor logic 440 determines that an image is to be rendered, the interceptor logic 440 determines a location (i.e., address) in memory associated with the image to be rendered. Upon determining the location, the interceptor logic 440 transmits data indicative location to the image management logic 444.

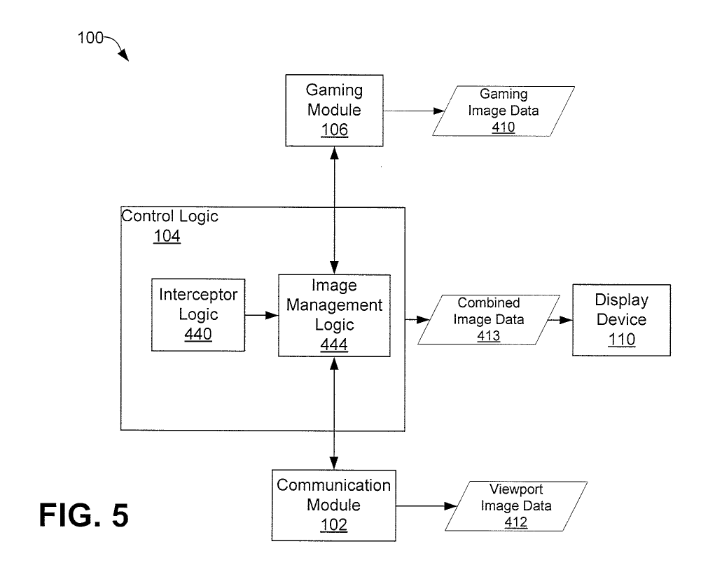

FIG. 5 is a block diagram depicting the functionality of the image rendering system 100. During operation, the gaming module 106 generates gaming image data 410, which is stored in memory 401 (FIG. 4).

The interceptor logic 440 monitors the rendering operations of the image rendering system 100 by determining if a predetermined sequence of function calls to the rendering logic 181 has occurred. Upon determining that gaming image data 410 is ready to be rendered to the display device 110 (FIG. 1), the interceptor logic 440 captures data indicative of the gaming image data 410. In this regard, the interceptor logic 444 may determine, for example, the memory location of the gaming image data 410. Note that the data indicative of the gaming image data 410 may be a pointer to that portion of the memory 401 storing the gaming image data 410. Further note that the gaming image data 410 may be a texture, for example. Specifically, the interceptor logic 440 monitors image rendering functions executed by the processor 400 that are provided by the rendering logic 181. In one embodiment, for example, the interceptor logic 440 monitors “stretchrect” and “present” function calls. Note that this can be done through a customized dynamic link library (dll) that is executed in place of the dll typically called by the gaming module 106 when rendering and displaying the gaming image data 410. Further note that the frequency that “present” is called plays into the frame rate at which an image is displayed to the display device 110. For exemplary purposes, assume a 60-hertz refresh rate, which indicates that a new image may be rendered and displayed sixty times per second. In one embodiment, the interceptor logic 440 monitors and allows the render and display of the gaming image data 410 at least once, but on the next display (e.g., the next present that is called), which is approximately 16 milliseconds from the time the first gaming image data 410 is rendered and displayed, the interceptor logic 440 redirects operation to the image management logic 444 (i.e., does not allow the gaming image data 410 stored in memory) to be displayed. For ease of discussion and for purposes of this disclosure, the method encompassing the calling of stretchrect and present function calls to display the gaming image data 410 to the display device 110 is hereinafter referred to as a render pass.

Thus, for each render pass thereafter, the gaming image data 410 is not rendered and displayed to the display device 110. Instead, the image management logic 444 combines the gaming image data 410 (which is exemplified in viewport 301 of FIG. 3) with viewport image data 412 to generate the combined image data 413, which is ultimately displayed to the display device 110. At this point in the process, the control logic 104, and specifically the image management logic 444, has a memory address (or pointer) identifying the memory location of the gaming image data 410.

Additionally, the communication module 102 has generated viewport image data 412 to be displayed in the one or more additional viewports 302-304 of the viewport 300 (FIG. 3) in conjunction with the gaming image data 410 being displayed in the viewport 301. Notably, as described herein, the images displayed in the viewports 302-304 generated by the communication module 102 may be, for example, created by an image generator (e.g., Adobe Flash) as described hereinabove.

The communication module 102 transmits to the image management logic 444 memory addresses (or pointers) identifying the viewport image data 412. In one embodiment, the image management logic 444 retains a list of identifiers identifying the viewports contained in the viewport image data 412. Note that the list of identifiers may be, for example, a list of memory addresses (or pointers) at which the viewport image data 412 is stored in memory 401. Note that not all images for viewports 301-304 may be displayed.

During operation, the image management logic 444 receives messages from the one or more input devices 419. As described herein, the input devices 419 may be a mouse, a touch screen, or other hardware with which a user of the image rendering system 100 may provide input to the image rendering system 100.

Upon receipt of a message, the image management logic 444 determines whether an action is necessitated by the message, and if an action is necessitated, whether one or both of the gaming module 106 or the communication module 102 should be notified of the message. The image management logic 444 transmits the received message to the appropriate module (either one or both depending upon the message received).

As an example, with reference to FIG. 3, the user may select the pushbutton 392, which indicates that indicates that laser fire is to be used in the viewport 301. The user may select the pushbutton 392 via a touch screen (not shown) implemented in the image rendering system 100 on which the viewport 300 is displayed. Upon selection, the image management logic 330 receives a message indicating that a portion of the touch screen has been touched by the user. The image management logic 444 determines which (if any) viewport 301-304 corresponds to the portion of the screen that has been touched. In this example, a portion of the screen corresponding to viewport 304 has been touched, which indicates that the communication module 102 should handle the message. The image management logic 444 transmits the message to the communication module 102. The communication module 102 determines what (if any) action should be taken and notifies the image management logic 444. For this particular example, when a user selects pushbutton 392, the image 200 changes to incorporate an image indicative of laser fire, which is displayed in viewport 301, which is handled by the gaming logic 106. Thus, the image management logic 444 further transmits one or more messages to the gaming logic 106 to perform operations in response to selection of the pushbutton 392. In response to the message(s), the gaming logic 106 generates new gaming image data 410. In one embodiment, a plugin created by a third party (i.e., a developer other than the developer of the gaming logic 106) may generate the new gaming image data 410. For purposes of this disclosure, the plugin described is part of the gaming logic 106. that incorporates a graphical image of a laser device (not shown) into the image 200 and stores the new gaming image data 410, which is then displayed to the display device in the combined image data 413 via the image management logic 444 as described hereinabove.

As another example, the user may select another pushbutton that, when selected, indicates that information in one of the viewports 302-304 should be updated or changed. In such a scenario, the image management logic 444 receives a message indicating that the pushbutton has been selected. The image management logic 444 determines that such selection message is to be routed to the communication module 102 and transmits the message to the communication module 102. The communication module 102 generates new viewport image data 412 that incorporates a change relative to the selected pushbutton into the viewport image data 412, which is then displayed to the display device in the combined image data 413 via the image management logic 444 as described hereinabove.

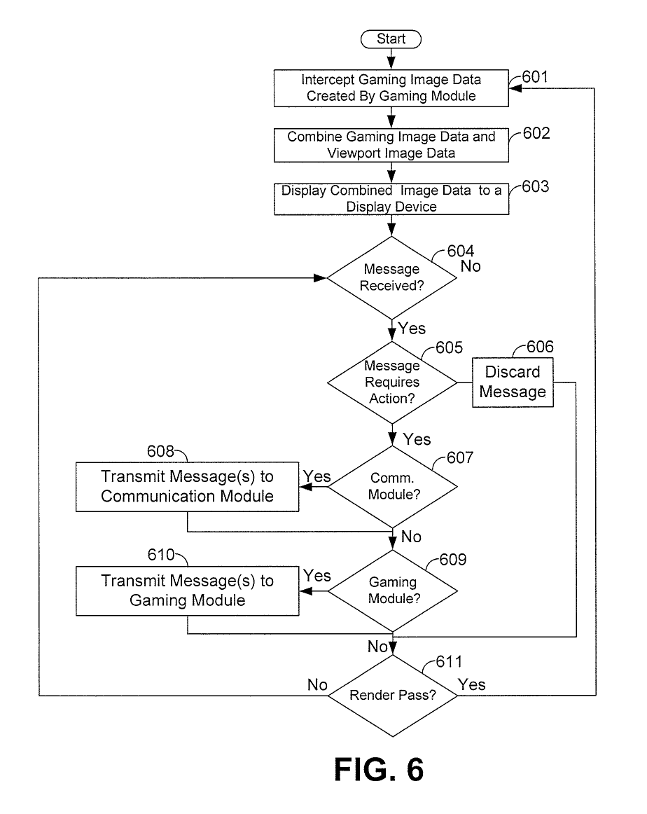

FIG. 6 is a flowchart depicting architecture and functionality of the control logic 104 (FIG. 1) in accordance with an embodiment of the present disclosure. In particular, the following discussion relates to an embodiment of the functionality of the interceptor logic 440 (FIG. 4) and the image management logic 444 (FIG. 4).

In step 601, the interceptor logic 440 intercepts the gaming image data 410 (FIG. 4) after one render pass of the gaming image data 410, i.e., the gaming image data 410 is displayed to the display device 110 (FIG. 1) at least once. As described herein, one method of performing such interception is to monitor rendering and displaying operations being performed by the gaming module 106 (FIG. 1) in conjunction with an operating system (not shown), and in the process of monitoring, a memory address of the gaming image data 410 is obtained.

In step 602 the image management logic 444 discerns a memory address of the gaming image data 410 and combines the gaming image data 410 and the viewport image data 412 (FIG. 4) into the combined image data 413 (FIG. 4). The image management logic 444 displays the combined image data 413 to the display device 110 in step 603. When the viewports are handled and displayed in such manner, each displayed viewport 301-304 may be separately controlled and/or managed irrespective of the other viewports 301-304. For example, each window may be sized and/or relocated on the display device in response to user input.

If the image management logic 444 receives a message, in step 604, the image management logic 444 determines whether the message requires action in step 605. The image management logic 444 may receive a message from the user interface (i.e., the user has selected or otherwise actuated a user interface device, pushbutton, etc.), the gaming module 106 and/or the communication module 102. Further, the action that is necessitated by the message received may vary as well. In this regard, the message may necessitate simply passing the received message along (e.g., to the gaming module 106 or the communication module 102) and/or generating a new message that comprises data indicating that the receiver of the message take certain actions.

Note that if the message requires no action be taken in step 605, the image management logic 606 simply discards the received message in step 606. If such discard takes place and a render pass is to be made in step 611, the image management logic 444 proceeds to step 601 and a render pass occurs in steps 601-603. However, it is not yet time for a render pass in step 611, the image management logic 444 continues back at step 604 and continues to process user interface messages, messages from the gaming module 106, or messages from the communication module 102.

If the received message is to be handled by the communication module 102 in step 607, the image management logic 444 transmits the message to communication module 102 in step 608. As an example, the user may select a pushbutton in one of the viewports 302-304, which necessitates information to be updated in another viewport 302-304. The image management logic 444 receives a user interface message and transmits such message to the communication module 102. Once the image management logic 444 transmits the message to the communication module in step 608, the image management logic 444 continues onto step 609. Once the image management logic 444 transmits the message to the communication module 102 in step 608 or if the image management logic 444 determines that the message did not necessitate transmission of the message received to the communication module 102, the image management logic 444 determines whether the message necessitates transmission of a message to the gaming module in step 609.

If it is determined that the message is to be handled by the gaming module 106 (FIG. 1) in step 609, the image management logic 444 transmits a message to the gaming module 106 in step 610. As an example, the user may select a pushbutton in one of the viewports 302-304, which necessitates appearance of a particular image in the viewport 301 (FIG. 3) on image 200 (FIG. 3). The image management logic 444 transmits such message to the gaming module 106.

Note that the message received in step 604 may necessitate transmission of more than one message to the communication module 102 and/or one or more message to the gaming module 106. In such a case, in steps 608 and 610, the image management logic 444 may transmit a plurality of messages to the communication module 102 or the gaming module 106, respectively.

Once the image management logic 444 has performed steps 607, 608 (if necessitated) and 609, 610 (if necessitated), the image management logic 444 continues to process messages received if it is not time for a render pass in step 611.

As another example of the control logic 104, assume that a user selects the pushbutton 392. When a user selects pushbutton 392 (either via a touch screen or otherwise), an image is to be inserted in the image 200 in viewport 301 of a laser device. In addition, a status of a light in viewport 202 is to be changed. In such an example, the image management logic 444 is making (or has made) a render pass or has been made when the user selects pushbutton 392, i.e., steps 601-603 were (or are being) executed. In such an example, the gaming module 106 is to make changes to the gaming image data 410 and the communication module 102 is to make changes to the viewport image data 412. Thus, in step 604, the message is received that the pushbutton 392 has been selected, and the image management logic 444 determines whether the message requires action in step 605. In step 607, the image management logic 444 sends the message received (and or a generated message(s)) to the communication module 102 to effectuate the changes responsive to the pushbutton 392 being selected in step 608. Additionally, the image management logic 444 sends the message received (and or a generated message(s)) to the gaming module 106 to effectuate the changes responsive to the pushbutton 392 being selected in step 610. If it is time for a render pass once the message has been processed, i.e., the messages necessary to effectuate changes to the viewport 301 have been sent to the corresponding modules 102, 106, the image management logic 444 performs a render pass, i.e., steps 601-603, as determined in step 611. If it is not time for a render pass, the image management logic 444 continues to process messages at step 604.

Note that the gaming module 106 and the communication module 102 perform operations related to the gaming image data 410 and the viewport image data 412 in response to messages received from the image management logic 444. Thus, in the combined image data 413 that is subsequently displayed to the display device 110 by the image management logic 444, as described hereinabove, modifications may be made to the viewports 301-304 based upon user input via the input devices 419.

1. A gaming system, comprising:
a gaming module configured to generate and render gaming image data to a display device;
a communication module configured to generate viewport image data;
logic configured to intercept a rendering operation of the gaming module and to determine a location of the gaming image data, the logic further configured to generate combined image data by combining the gaming image data with the viewport image data and to perform a rendering operation for display of the combined image data to the display device.

2. The system of claim 1, wherein the gaming module is virtual battlespace systems (VBS).

3. The system of claim 1, wherein the communication module is Scaleform GFx.

4. The system of claim 1, wherein logic monitors function calls of rendering logic.

5. The system of claim 4, wherein if a predetermined sequence of function calls is performed, the logic intercepts the rendering operation.

6. A gaming method, comprising:
intercepting a rendering operation of a gaming module corresponding to gaming image data generated by a gaming module;
determining a location in memory of the gaming image data;
generating combined image data by combining the gaming image data with viewport image data;
performing a rendering operation for display of the combined image data to the display device.

7. The method of claim 6, further comprising generating gaming image data via Virtual Battlespace (VBS).

8. The method of claim 6, further comprising generating viewport image data via Scaleform GFx.

9. The method of claim 6 further comprising monitoring function calls of rendering logic.

10. The method of claim 9, further comprising wherein if a predetermined sequence of function calls is performed, intercepting the rendering operation.
